(19) United States
(12) Patent Application Publication
(10) Pub. No.: US 2026/0089592 A1
(43) Pub. Date: Mar. 26, 2026

(54) METHODS AND APPARATUSES FOR UL SYNCHRONIZATION AND DL SYNCHRONIZATION

(71) Applicant: Lenovo (Beijing) Limited, Beijing (CN)

(72) Inventors: Lianhai Wu, Beijing (CN); Congchi Zhang, Shanghai (CN); Shuigen Yang, Shanghai (CN); Le Yan, Shanghai (CN)

(73) Assignee: Lenovo (Beijing) Limited, Beijing (CN)

(21) Appl. No.: 19/112,669

(22) PCT Filed: Dec. 20, 2022
(86) PCT No.: PCT/CN2022/140342

§ 371 Date: Mar. 18, 2025

(51) Int. Cl. H04W 36/08; H04W 56/00; H04W 74/0833; H04W 76/20

(52) U.S. Cl. CPC H04W 36/08; H04W 56/0045; H04W 74/0833; H04W 76/20

(57) ABSTRACT

Embodiments of the present application relate to methods and apparatuses for uplink (UL) synchronization and downlink (DL) synchronization in a lower layer-based mobility case under a 3rd Generation Partnership Project (3GPP) 5G system or the like. According to an embodiment of the present application, a candidate distributed unit (DU) of a base station (BS) includes a transceiver 2024/082427 and a processor coupled to the transceiver, and the processor is configured to cause the candidate DU to: receive a request from a centralized unit (CU) of the BS, wherein the request includes identifier (ID) information of one or more candidate cells; and transmit, based on the request, a response message to the CU, wherein the response message is associated with a cell switching procedure.

### TECHNICAL FIELD

Embodiments of the present application generally relate to wireless communication technology, especially to methods and apparatuses for lower layer-based mobility with uplink (UL) synchronization and downlink (DL) synchronization before cell switching.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding UL synchronization and DL synchronization in a lower layer-based mobility case have not been discussed in 3GPP 5G technology yet.

### SUMMARY

Some embodiments of the present application provide a candidate distributed unit (DU) of a base station (BS). The candidate DU includes a transceiver and a processor coupled to the transceiver; and the processor is configured to cause the candidate DU to: receive a first request from a centralized unit (CU) of the BS, wherein the first request includes identifier (ID) information of one or more candidate cells; and transmit, based on the first request, a response message to the CU, wherein the response message is associated with a cell switching procedure.

In some embodiments of the present application, the response massage includes at least one of: lower layer radio resource control (RRC) configuration information associated with at least one candidate cell within the one or more candidate cells; random access channel (RACH) configuration information for a timing advance (TA) acquisition procedure performed by a user equipment (UE); a first indication for indicating whether the TA acquisition procedure is performed by the UE before the cell switching procedure for the at least one candidate cell or not; or a second indication for indicating whether a downlink (DL) synchronization operation is performed by the UE before the cell switching procedure for the at least one candidate cell or not.

In the embodiments of the present application, TA acquisition or early TA acquisition means that the UE is expected to perform a TA acquisition procedure before a cell switching procedure. TA acquisition or early TA acquisition may be triggered by the reception of an indication from the serving BS, e.g., a physical downlink control channel (PDCCH) order which is downlink control information (DCI).

In some embodiments of the present application, the RACH configuration information includes at least one of: a random access (RA) preamble index; a synchronization signal/physical broadcast channel (SS/PBCH) index; or an RACH occasion (RO).

In some embodiments of the present application, the RACH configuration information is included in a dedicated IE in the response message; or the lower layer RRC configuration information is included in one or more IEs in the response message, and the RACH configuration information is merged to the one or more IEs.

In some embodiments of the present application, the RACH configuration information is included in a DU to CU RRC information IE included in the response message.

In some embodiments of the present application, the first request further includes at least one of: a third indication for indicating whether the TA acquisition procedure is performed by the UE before the cell switching procedure for a candidate cell within the one or more candidate cells or not; or a fourth indication for indicating whether a downlink (DL) synchronization operation is performed by the UE before the cell switching procedure for the candidate cell or not.

In some embodiments of the present application, the first request further includes at least one of: a fifth indication for indicating that the first request is for lower layer triggered mobility (LTM); ID information of a source DU of the BS; ID information of the UE; or ID information of a source cell of the UE.

In some embodiments of the present application, the processor is configured to cause the candidate DU to identify, based on the first request, whether the at least one candidate cell and a first candidate cell within the one or more candidate cells have a same TA value for the UE, and if the at least one candidate cell and the first candidate cell have the same TA value for the UE, the response message further includes at least one of: a sixth indication for indicating whether a first TA value related to the at least one candidate cell is same as a second TA value related to the first candidate cell; or ID information of the first candidate cell.

In some embodiments of the present application, the first request is received from the CU via an F1 interface, the first request is a UE context setup request message or a UE context modification request message; or the response message is transmitted to the CU via the F1 interface, and the response message is a UE context setup response message or a UE context modification response message.

Some embodiments of the present application provide a centralized unit (CU) of a base station (BS). The CU includes a transceiver and a processor coupled to the transceiver; and the processor is configured to cause the CU to: transmit a first request to a candidate distributed unit (DU) of the BS, wherein the first request includes identifier (ID) information of one or more candidate cells; and receive a response message from the candidate DU, wherein the response message is associated with a cell switching procedure.

In some embodiments of the present application, the response message includes at least one of: lower layer radio resource control (RRC) configuration information associated with at least one candidate cell within the one or more candidate cells; random access channel (RACH) configuration information for a timing advance (TA) acquisition procedure performed by a user equipment (UE); a first indication for indicating whether the TA acquisition procedure is performed by the UE before the cell switching procedure for the at least one candidate cell or not; or a second indication for indicating whether a downlink (DL) synchronization operation is performed by the UE before the cell switching procedure for the at least one candidate cell or not.

In some embodiments of the present application, the processor is configured to cause the CU to transmit a first message to a source DU of the BS, the first message includes the RRC configuration information associated with the at least one candidate cell, and the RRC configuration information includes the lower layer RRC configuration information.

In some embodiments of the present application, the first message further includes first information, and the first information includes at least one of: a third indication for indicating whether the TA acquisition procedure is performed by the UE before the cell switching procedure for the at least one candidate cell or not; or a fourth indication for indicating whether a DL synchronization operation is performed by the UE before the cell switching procedure for the at least one candidate cell or not; or the RACH configuration information.

In some embodiments of the present application, the first information is included in or is outside of the RRC configuration information in the first message.

In some embodiments of the present application, the RACH configuration information includes at least one of: a random access (RA) preamble index; a synchronization signal/physical broadcast channel (SS/PBCH) index; or an RACH occasion (RO).

In some embodiments of the present application, the RACH configuration information is included in a dedicated information element (IE) in the first message; or the first message includes one or more IEs including the lower layer RRC configuration information, and the RACH configuration information is merged to the one or more IEs.

In some embodiments of the present application, the RACH configuration information is included in a CU to DU RRC information IE included in the first message.

In some embodiments of the present application, the first request is transmitted to the candidate DU via a first F1 interface, and the first request is a UE context setup request message or a UE context modification request message; or the response message is received from the candidates DU via the first F1 interface, and the response message is a UE context setup response message or a UE context modification response message; or the first message is transmitted to the source DU via a second F1 interface, and the first message is a DL RRC message transfer message or a UE context modification request message.

In some embodiments of the present application, at least one of the response message or the first message further includes at least one of: a fifth indication for indicating whether a first TA value related to the at least one candidate cell is same as a second TA value related to a first candidate cell within the one or more candidate cells; or ID information of the first candidate cell.

In some embodiments of the present application, the processor is configured to cause the CU to receive the first request from a source DU of the BS.

In some embodiments of the present application, the first request further includes at least one of: a sixth indication for indicating whether the TA acquisition procedure is performed by the UE before the cell switching procedure for a candidate cell within the one or more candidate cells or not; or a seventh indication for indicating whether a downlink (DL) synchronization operation is performed by the UE before the cell switching procedure for the candidate cell or not.

In some embodiments of the present application, the first request further includes at least one of: an eighth indication for indicating that the first request is for lower layer triggered mobility (LTM); ID information of a source DU of the BS; ID information of the UE; or ID information of a source cell of the UE.

In some embodiments of the present application, the RACH configuration information is included in a dedicated information element (IE) in the response message; or the lower layer RRC configuration information is included in one or more IEs in the response message, and the RACH configuration information is merged to the one or more IEs.

In some embodiments of the present application, the RACH configuration information is included in a DU to CU RRC information IE included in the response message.

Some embodiments of the present application provide a source distributed unit (DU) of a base station (BS). The source DU includes a transceiver and a processor coupled to the transceiver; and the processor is configured to cause the source DU to: receive a first message from a centralized unit (CU) of the BS, wherein the first message includes radio resource control (RRC) configuration information associated with at least one candidate cell related to a cell switching procedure; and transmit a second message including the RRC configuration information to a user equipment (UE).

In some embodiments of the present application, the first message further includes first information, and the first information includes at least one of: a first indication for indicating whether a timing advance (TA) acquisition is performed by the UE before the cell switching procedure for the at least one candidate cell or not; or a second indication for indicating whether a downlink (DL) synchronization operation is performed by the UE before the cell switching procedure for the at least one candidate cell or not; or random access channel (RACH) configuration information for the TA acquisition procedure performed by the UE.

In some embodiments of the present application, the first information is included in or is outside of the RRC configuration information in the first message.

In some embodiments of the present application, the RACH configuration information is included in a dedicated information element (IE) in the first message; or the lower layer RRC configuration information is included in one or more IEs in the first message, and the RACH configuration information is merged to the one or more IEs.

In some embodiments of the present application, the RACH configuration information is included in a CU to DU RRC information IE included in the first message.

In some embodiments of the present application, at least one of the first message or the second message further includes at least one of: a third indication for indicating whether a first TA value related to the at least one candidate cell is the same as a second TA value related to a first candidate cell associated with the LTM; or ID information of the first candidate cell.

In some embodiments of the present application, before receiving the first message, the processor is configured to cause the source DU to transmit a first request for requesting a random access channel (RACH) resource for a timing advance (TA) acquisition procedure performed by the UE to the CU.

In some embodiments of the present application, the second message is an RRC reconfiguration message.

In some embodiments of the present application, the second message further includes at least one of: a fourth indication for indicating whether a timing advance (TA) acquisition procedure is performed by the UE before the cell switching procedure for the at least one candidate cell or not; a fifth indication for indicating whether a downlink (DL) synchronization operation is performed by the UE before the cell switching procedure for the at least one candidate cell or not; or RACH configuration information for the TA acquisition procedure performed by the UE.

In some embodiments of the present application, the RACH configuration information includes at least one of: a random access (RA) preamble index; a synchronization signal/physical broadcast channel (SS/PBCH) index; or an RACH occasion (RO).

In some embodiments of the present application, after transmitting the second message, the processor is configured to cause the source DU to transmit a sixth indication to indicate at least one of: to perform a timing advance (TA) acquisition procedure; whether to create a dedicated medium access control (MAC) entity associated with the at least one candidate cell for the TA acquisition procedure performed by the UE; or to perform a downlink (DL) synchronization operation to the at least one candidate cell.

In some embodiments of the present application, sixth indication is included in: a physical downlink control channel (PDCCH) order; downlink control information (DCI); or a medium access control (MAC) control element (CE).

Some embodiments of the present application provide a user equipment (UE). The UE includes a transceiver and a processor coupled to the transceiver; and the processor is configured to cause the UE to: receive a first message from a source distributed unit (DU) of a base station (BS), wherein the first message includes radio resource control (RRC) configuration information associated with at least one candidate cell related to a cell switching procedure; and receive a first indication to trigger a timing advance (TA) acquisition procedure or a downlink (DL) synchronization operation from the source DU.

In some embodiments of the present application, the first message is an RRC reconfiguration message.

In some embodiments of the present application, the first message further includes at least one of: a second indication for indicating whether the TA acquisition procedure is performed by the UE before the cell switching procedure for the at least one candidate cell or not; a third indication for indicating whether a downlink (DL) synchronization operation is performed by the UE before the cell switching procedure for the at least one candidate cell or not; or random access channel (RACH) configuration information for the TA acquisition procedure.

In some embodiments of the present application, the RACH configuration information includes at least one of: a random access (RA) preamble index; a synchronization signal/physical broadcast channel (SS/PBCH) index; or an RACH occasion (RO).

In some embodiments of the present application, the first message further includes at least one of: a fourth indication for indicating whether a first TA value related to the at least one candidate cell is the same as a second TA value related to a first candidate cell associated with the LTM; or ID information of the first candidate cell.

In some embodiments of the present application, the processor configured to cause the UE to start to perform the DL synchronization operation to the at least one candidate cell after receiving the first message.

In some embodiments of the present application, the processor is configured to cause the UE to perform the TA acquisition procedure before the cell switching procedure after receiving the RRC configuration information associated with the at least one candidate cell.

In some embodiments of the present application, the processor is configured to cause the UE to perform the TA acquisition procedure based on a MAC entity of the UE or an RLC entity of the UE.

In some embodiments of the present application, the processor is configured to cause the UE to determine to create a dedicated medium access control (MAC) entity for the TA acquisition procedure based on one of the following: receiving a fifth indication from the source DU, and the fifth indication indicates the UE to create a MAC entity associated with the at least one candidate cell for the TA acquisition procedure; an index of a candidate distributed unit (DU) of the BS is different from an index of the source DU; or an index of a candidate cell group of the BS is different from an index of a source cell group of the BS.

In some embodiments of the present application, the fifth indication is included in: the first message; a physical downlink control channel (PDCCH) order; downlink control information (DCI); or a medium access control (MAC) control element (CE).

In some embodiments of the present application, in response to determining to create the dedicated MAC entity for the TA acquisition procedure, the processor is configured to cause the UE to perform at least one of: creating the MAC entity for the TA acquisition procedure; or creating a radio link control (RLC) entity associated with the at least one candidate cell for the TA acquisition procedure.

In some embodiments of the present application, at least one of the MAC entity or the RLC entity is created by the UE based on default configuration information configured to the UE, and wherein the processor is configured to cause the UE to release both the MAC entity and the RLC entity after acquiring a TA value related to the at least one candidate cell by the TA acquisition procedure.

In some embodiments of the present application, at least one of the MAC entity or the RLC entity is created by the UE based on the RRC configuration information associated with the at least one candidate cell, and wherein the processor is configured to cause the UE to keep the at least one of the MAC entity or the RLC entity after acquiring a TA value related to the at least one candidate cell by the TA acquisition procedure.

In some embodiments of the present application, if the at least one candidate cell includes a second candidate cell and a third candidate cell, the processor is configured to cause the UE to: create at least one of a first MAC entity or a first RLC entity for the second candidate cell, and keep the at least one of the first MAC entity or the first RLC entity after acquiring a TA value related to the second candidate cell; and create at least one of a second MAC entity or a second RLC entity for the third candidate cell, and keep the at least one of the second MAC entity or the second RLC entity after acquiring a TA value related to the third candidate cell.

In some embodiments of the present application, the processor is configured to cause the UE to: receive a cell switch command associated with the third candidate cell from the source DU; and keep or release the at least one of the first MAC entity or the first RLC entity after switching from the source cell of the UE to the third candidate cell.

Some embodiments of the present application provide a method performed by a candidate distributed unit (DU) of a base station (BS). The method includes: receiving a first request from a centralized unit (CU) of the BS, wherein the first request includes identifier (ID) information of one or more candidate cells; and transmitting, based on the first request, a response message to the CU, wherein the response message is associated with a cell switching procedure.

Some embodiments of the present application provide a method performed by a centralized unit (CU) of a base station (BS). The method includes: transmitting a first request to a candidate distributed unit (DU) of the BS, wherein the first request includes identifier (ID) information of one or more candidate cells; and receiving a response message from the candidate DU, wherein the response message is associated with a cell switching procedure.

Some embodiments of the present application provide a method performed by a source distributed unit (DU) of a base station (BS). The method includes: receiving a first message from a centralized unit (CU) of the BS, wherein the first message includes radio resource control (RRC) configuration information associated with at least one candidate cell related to a cell switching procedure; and transmitting a second message including the RRC configuration information to a user equipment (UE).

Some embodiments of the present application provide a method performed by a UE. The method includes: receiving a first message from a source distributed unit (DU) of a base station (BS), wherein the first message includes radio resource control (RRC) configuration information associated with at least one candidate cell related to a cell switching procedure; and receiving a first indication to trigger a timing advance (TA) acquisition procedure or a downlink (DL) synchronization operation from the source DU.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates a schematic diagram of inter-cell Layer1/Layer2 (L1/L2) mobility in accordance with some embodiments of the present application.

FIGS. 3-6 illustrate exemplary flowcharts associated with a cell switching procedure in accordance with some embodiments of the present application.

FIGS. 7-9 illustrate exemplary flowcharts of performing a cell switching procedure in accordance with some embodiments of the present application.

FIG. 10 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

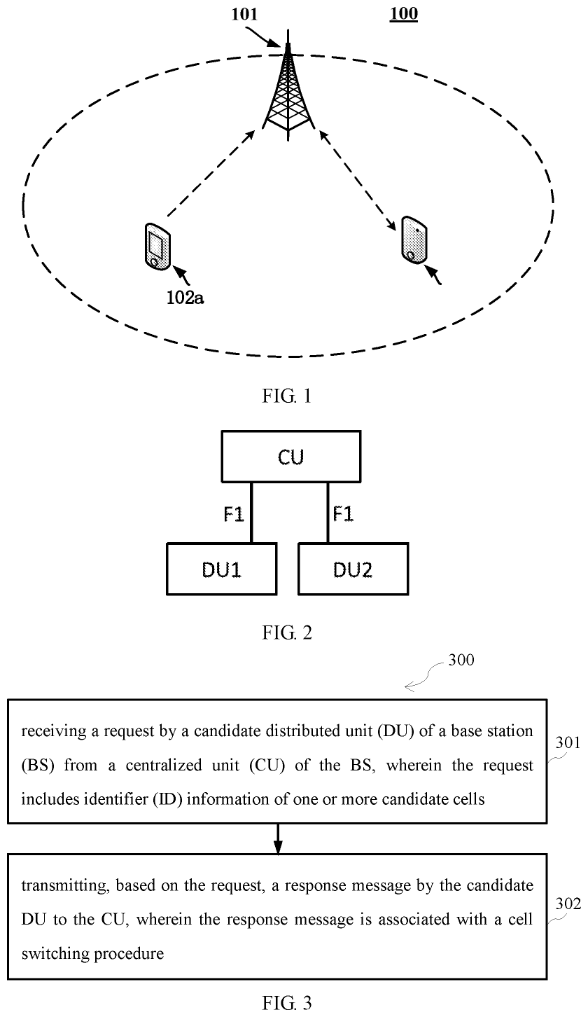

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g., gNB) may switch a UE to a new cell using L1/L2 signaling taking into account the received physical layer measurement result. In accordance with 3GPP standard documents, a BS may consist of a BS-centralized unit (CU) and one or more BS-distributed unit(s) (DU(s)). A BS-CU and a BS-DU are connected via an F1 interface which is a logical interface. One BS-DU is connected to only one BS-CU.

FIG. 2 illustrates a schematic diagram of inter-cell Layer1/Layer2 (L1/L2) mobility in accordance with some embodiments of the present application. As shown in FIG. 2, CU may communicate with two DUs, i.e., DU1 or DU2, via F1 interfaces. CU in FIG. 2 may implement legacy mobility decision based on Layer 3 (L3) measurement result. DU1 or DU2 in FIG. 2 may implement L1/L2 mobility decision based on physical layer measurement result(s).

Compared to legacy L3 mobility, L1/L2 mobility is considered faster with less processing delay and signaling delay. In legacy L3 mobility, a CU (e.g., CU as shown in FIG. 2) makes the mobility decision based on received radio resource management (RRM) measurement report. Different than legacy L3 mobility, in L1/L2 mobility, a DU (e.g., DU1 or DU2 as shown in FIG. 2) makes the mobility decision based on physical layer measurement result, e.g., carried in a channel state information (CSI) report. Besides, in legacy L3 mobility, the handover command is sent via an RRC message from the SN CU to a UE, while in L1/L2 mobility, the “handover” command is sent via L1/L2 signaling (e.g., downlink control information (DCI) or a medium access control (MAC) control element (CE)) from the DU to a UE. The “handover” command in L1/L2 mobility can be about cell activation or deactivation, e.g., activate a new serving PCell while deactivate the old serving PCell.

Currently, issues of UL synchronization and DL synchronization in a lower layer-based mobility case have not been solved. Embodiments of the present application aim to solve such issues. For instance, some embodiments of the present application study initiation of a TA acquisition procedure, e.g., candidate DU-based initiation, source DU-based initiation, and CU based initiation of the TA acquisition procedure. Some embodiments of the present application study a mechanism in which two candidate cells have the same TA value and a UE is not expected to be triggered by a PDCCH order twice. The mechanism is enhanced to support the avoidance of getting same TA value. In the embodiments of the present application, TA acquisition or early TA acquisition means that a UE is expected to perform a TA acquisition procedure before a cell switching procedure. TA acquisition or early TA acquisition may be triggered by the reception of an indication from the serving BS, e.g., a PDCCH order which is DCI.

Some embodiments of the present application study a mechanism of whether another protocol stack, e.g., an MAC entity, should be created when a UE receives a PDCCH order and how to determine whether to create an MAC entity for RACH or not. Some embodiments of the present application enhance F1 signalling to support that a network (e.g., a candidate cell) configures a DL synchronization operation for a part of candidate cell(s). Some embodiments of the present application study when the UE begins to perform a DL synchronization operation for the part of candidate cell(s).

Some embodiments of the present application may be applicable for a case of “lower layer triggered mobility” or “L1/L2 triggered mobility”, and the abbreviation of at least one of them may be “LTM”. In an LTM case, a UE may access a serving BS (e.g., a serving gNB). The UE may report Layer3 (L3) measurement result(s) based on the configuration from the serving gNB. If the serving gNB, e.g., a CU of the serving gNB, decides to switch the UE to a candidate cell based on the measurement result(s), the serving gNB may request target DU(s) to prepare the configuration for one or more candidate cells. After receiving the candidate cell configuration from a target DU of the serving gNB, the serving gNB may transmit an RRC reconfiguration message including ID information of one or more candidate cells to the UE. For example, the CU may transmit the RRC reconfiguration message to the UE via a source DU of the serving gNB. The UE may transmit an RRC reconfiguration complete message to the serving gNB (e.g., CU) via the source DU. The UE may ensure UL synchronization or DL synchronization before receiving a cell switch command. For example, the UE may get or acquire a TA value via a random access (RA) or preamble transmission. The UE may report Layer1 (L1) measurement result(s) for a dynamic switching purpose. The serving gNB, e.g., the source DU, may transmit a cell switch command, e.g., a MAC CE or DCI. The UE can apply the RRC reconfiguration message and start a timer upon receiving the lower layer command.

In particular, in embodiments of FIGS. 3-10 of the present application, both inter-DU mobility scenario and intra-DU mobility scenario are considered, e.g., inter-gNB-DU LTM or intra-gNB-DU LTM. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 3 illustrates an exemplary flowchart associated with a cell switching procedure in accordance with some embodiments of the present application. The exemplary flowchart 300 in the embodiments of FIG. 3 may be performed by a candidate DU (e.g., DU1 or DU2 as shown and illustrated in FIG. 2). A candidate DU may also be named as a target DU in some cases. Although described with respect to a candidate DU, it should be understood that other devices may be configured to perform a flowchart similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-10.

In the exemplary flowchart 300, in operation 301, a candidate DU of a BS (e.g., DU1 as shown and illustrated in FIG. 2) may receive a request from a CU of the BS (e.g., CU as shown and illustrated in FIG. 2). The request may include ID information of one or more candidate cells.

In some embodiments, the request is received from the CU via an F1 interface. The request may be named as an F1 request message or the like. For instance, the request may be a UE context setup request message or a UE context modification request message. In some embodiments, the request is received by the CU from a source DU of the BS (e.g., DU2 as shown and illustrated in FIG. 2) and then transmitted to the candidate DU.

In operation 302 as shown in FIG. 3, the candidate DU may transmit, based on the request, a response message which is associated with a cell switching procedure to the CU. In some embodiments, the candidate DU may determine whether to accept the request received in operation 301, and the response message is transmitted to the CU in response to determining to accept the request.

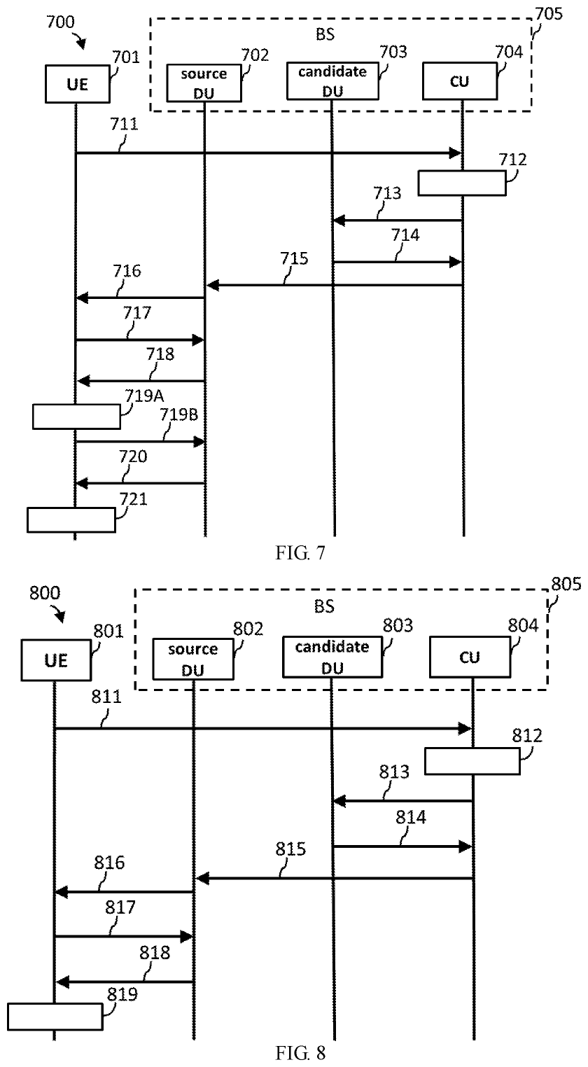

In some embodiments, the response message is transmitted to the CU via the F1 interface in operation 302. The response message may be named as an F1 response message or the like. For instance, the response message may be a UE context setup response message or a UE context modification response message. Specific examples are described in the embodiments of FIGS. 7 and 8 s follows.

In some embodiments, the response massage in operation 302 includes at least one of the following:
(1) Lower layer RRC configuration information associated with at least one candidate cell within the one or more candidate cells. For example, the lower layer RRC configuration information may be named as “lower layer RRC configuration for LTM”, “L1/L2 RRC configuration information for LTM”, “RRC configuration for LTM”, “LTM configuration information” or the like.
(2) RACH configuration information for a TA acquisition procedure performed by a UE (e.g., UE 102 as shown and illustrated in FIG. 1). The RACH configuration information may be named as “RACH configuration for TA acquisition” or the like. In some embodiments, the RACH configuration information includes at least one of: an RA preamble index; an SS/PBCH index; or an RO. In some embodiments, the candidate DU generates the RACH configuration information after receiving the request in operation 301.
(3) An indication (denoted as indication #1 for simplicity) for indicating whether the TA acquisition procedure is performed by the UE before the cell switching procedure for the at least one candidate cell or not. Indication #1 may be named as “an indication for early TA acquisition” or the like. Early TA acquisition means that the UE is expected to perform a TA acquisition procedure before a cell switching procedure.
(4) An indication (denoted as indication #2 for simplicity) for indicating whether a DL synchronization operation is performed by the UE before the cell switching procedure for the at least one candidate cell or not. Indication #2 may be named as “an indication for early DL synchronization” or the like. Early DL synchronization means that the UE is expected to perform a DL synchronization operation before a cell switching procedure. A specific example is described in the embodiments of FIG. 7 as follows.

In some embodiments, the lower layer RRC configuration information is included in one or more IEs in the response message, and the RACH configuration information is merged to these one or more IEs. In these embodiments, indication #1 may be included in the response message. If indication #1 is not included in the response message, the CU needs to read the container. If a RACH resource for TA acquisition is included, the CU needs to transmit an indication for early TA acquisition and indicate the corresponding RACH resource (e.g., the RACH configuration for TA acquisition) to the source DU.

In some other embodiments, the RACH configuration for TA acquisition is included in a dedicated IE in the response message. Namely, the RACH configuration for TA acquisition is not merged to the lower layer RRC configuration for LTM. In these embodiments, if indication #1 is not included, the RACH configuration for TA acquisition as a separate IE in the response message can be used to implicitly indicate early TA acquisition, i.e., the RACH configuration for TA acquisition may implicitly indicate that the UE is expected to perform a TA acquisition procedure before a cell switching procedure.

In an embodiment, the RACH configuration for TA acquisition is included in “DU to CU RRC information IE” (as specified in 3GPP standard document TS38.473) included in the response message. For instance, the RACH configuration for TA acquisition may be included in “DU to CU RRC information IE” as a separate IE, e. g, as a sub-IE of “DU to CU RRC information IE” of the response message. In another embodiment, the RACH configuration for TA acquisition is included in the response message as an IE outside of “DU to CU RRC information IE” included in the response message, e. g, as an IE in parallel with “DU to CU RRC information IE”.

In some embodiments, the request received by the candidate DU in operation 301 further includes at least one of the following:
(1) An indication (denoted as indication #3 for simplicity) for indicating whether the TA acquisition procedure is performed by the UE before the cell switching procedure for a candidate cell within the one or more candidate cells or not. Indication #3 may be named as “an indication for early TA acquisition” or the like.
(2) An indication (denoted as indication #4 for simplicity) for indicating whether a DL synchronization operation is performed by the UE before a cell switching procedure for the candidate cell or not. Indication #4 may be named as “an indication for early DL synchronization” or the like. A specific example is described in the embodiments of FIG. 7 as follows.

In some embodiments, the request received by the candidate DU in operation 301 further includes at least one of the following:
(1) An indication (denoted as indication #5 for simplicity) for indicating that the request is for LTM. For instance, indication #5 indicates that the request is for requesting RRC configuration for LTM.
(2) Id Information of a Source Du of the Bs.
(3) ID information of the UE.
(4) ID information of a source cell of the UE. A specific example is described in the embodiments of FIG. 8 as follows.

In some embodiments, the candidate DU may identify, based on the request, whether the at least one candidate cell and another candidate cell (denoted as candidate cell #1 for simplicity) within the one or more candidate cells have a same TA value for the UE. If the at least one candidate cell and candidate cell #1 have the same TA value for the UE, the response message further includes at least one of the following:
(1) An indication (denoted as indication #6 for simplicity) for indicating whether a TA value related to the at least one candidate cell is same as a TA value related to candidate cell #1.
(2) ID information of candidate cell #1. For example, if the TA value related to the at least one candidate cell is the same as the TA value related to candidate cell #1, the response message further includes ID information of candidate cell #1. A specific example is described in the embodiments of FIG. 8 as follows.

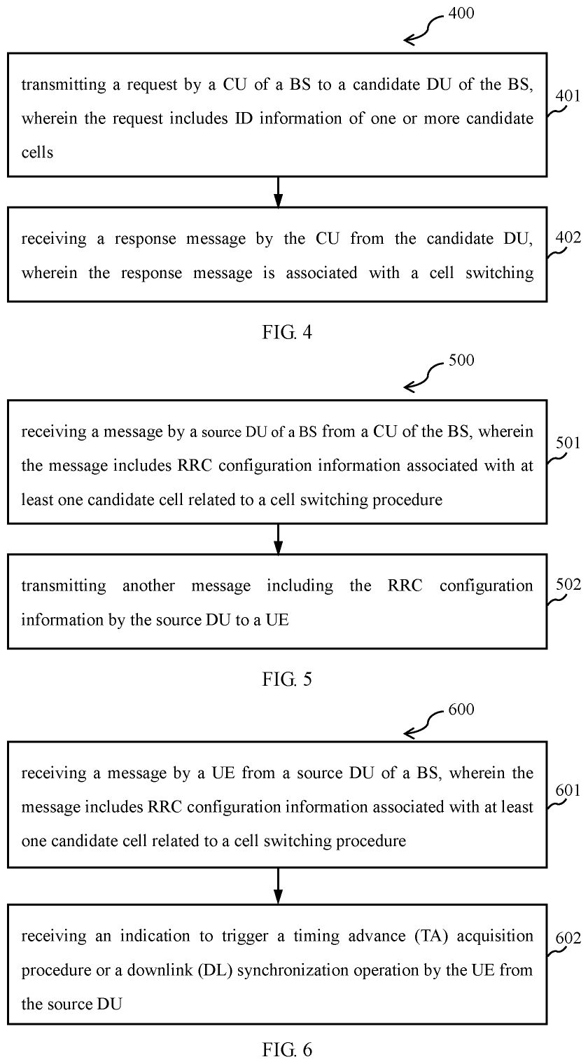

FIG. 4 illustrates a further exemplary flowchart associated with a cell switching procedure in accordance with some embodiments of the present application. The exemplary flowchart 400 in the embodiments of FIG. 4 may be performed by a CU (e.g., CU as shown and illustrated in FIG. 2). Although described with respect to a CU, it should be understood that other devices may be configured to perform a flowchart similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-10.

In the exemplary flowchart 400 as shown in FIG. 4, in operation 401, a CU (e.g., CU as shown and illustrated in FIG. 2) may transmit a request, which includes ID information of one or more candidate cells, to a candidate DU of the BS (e.g., DU1 as shown and illustrated in FIG. 2). In some embodiments, the request is transmitted to the candidate DU via an F1 interface. For instance, the request may be a UE context setup request message or a UE context modification request message.

In some embodiments, the request transmitted by the CU in operation 401 further includes at least one of the following:
(1) An indication for indicating whether the TA acquisition procedure is performed by the UE before the cell switching procedure for a candidate cell within the one or more candidate cells or not, e.g., an indication for early TA acquisition (e.g., indication #3 as described in the embodiments of FIG. 3).
(2) An indication for indicating whether a DL synchronization operation is performed by the UE before the cell switching procedure for the candidate cell or not, e.g., an indication for early DL synchronization (e.g., indication #4 as described in the embodiments of FIG. 3). A specific example is described in the embodiments of FIG. 7 as follows.

In some embodiments, the request transmitted by the CU in operation 401 further includes at least one of the following:
(1) an indication for indicating that the request is for lower layer triggered mobility (LTM) (e.g., indication #5 as described in the embodiments of FIG. 3);
(2) ID information of a source DU of the BS;
(3) Id Information of the Ue; or
(4) ID information of a source cell of the UE. A specific example is described in the embodiments of FIG. 8 as follows.

In some embodiments, the CU may receive the request from a source DU of the BS (e.g., DU2 as shown and illustrated in FIG. 2), e. g, via an F1 interface, and then transmit the request to the candidate DU in operation 401.

In operation 402 as shown in FIG. 4, the CU may receive a response message, which is associated with a cell switching procedure, from the candidate DU. In some embodiments, the response message is received via the F1 interface. For instance, the response message is a UE context setup response message or a UE context modification response message.

In some embodiments, the response message received by the CU in operation 402 includes at least one of the following:
(1) Lower layer RRC configuration information associated with at least one candidate cell within the one or more candidate cells, which may be named as “lower layer RRC configuration for LTM”, “L1/L2 RRC configuration information for LTM”, “RRC configuration for LTM”, “LTM configuration information” or the like.
(2) RACH configuration information for a TA acquisition procedure performed by a UE (e.g., UE 102 as shown and illustrated in FIG. 1), e.g., “RACH configuration for TA acquisition”. In some embodiments, the RACH configuration information includes at least one of: an RA preamble index; an SS/PBCH index; or an RO.
(3) An indication for indicating whether the TA acquisition procedure is performed by the UE before the cell switching procedure for the at least one candidate cell or not, e.g., an indication for early TA acquisition (e.g., indication #1 as described in the embodiments of FIG. 3).
(4) An indication for indicating whether a DL synchronization operation is performed by the UE before the cell switching procedure for the at least one candidate cell or not, e.g., an indication for early DL synchronization (e.g., indication #2 as described in the embodiments of FIG. 3). A specific example is described in the embodiments of FIG. 7 as follows.

In some embodiments, the RACH configuration information is included in a dedicated IE in the response message. In an embodiment, the RACH configuration information is included in “DU to CU RRC information IE” (as specified in 3GPP standard document TS38.473) included in the response message, e.g., as a sub-IE of “DU to CU RRC information IE”. In another embodiment, the RACH configuration information is included in the response message as an IE outside of “DU to CU RRC information IE”, e.g., in parallel with “DU to CU RRC information IE”.

In some other embodiments, the lower layer RRC configuration information is included in one or more IEs in the response message, and the RACH configuration information is merged to the one or more IEs.

In some embodiments, the response message received by the CU in operation 402 further includes at least one of:
(1) An indication for indicating whether a TA value related to the at least one candidate cell is the same as a TA value related to another candidate cell (e.g., candidate cell #1 as described in the embodiments of FIG. 3) within the one or more candidate cells, e.g., indication #6 as described in the embodiments of FIG. 3.
(2) ID information of the another candidate cell, if the TA value related to the at least one candidate cell is the same as the TA value related to the another candidate cell. A specific example is described in the embodiments of FIG. 8 as follows.

In some embodiments, the CU may transmit a message (denoted as message #1 for simplicity) to a source DU of the BS (e.g., DU2 as shown and illustrated in FIG. 2). Message #1 may include the RRC configuration information associated with the at least one candidate cell. For instance, message #1 may include an RRC reconfiguration message which includes the RRC configuration information. The RRC configuration information may include the lower layer RRC configuration for LTM.

In some embodiments, message #1 is transmitted to the source DU via an F1 interface. For instance, message #1 may be a DL RRC message transfer message or a UE context modification request message.

In some embodiments, message #1 further includes information (denoted as information #1 for simplicity) which includes at least one of the following:
(1) An indication (denoted as indication #7 for simplicity) for indicating whether the TA acquisition procedure is performed by the UE before the cell switching procedure for the at least one candidate cell or not, e.g., an indication for early TA acquisition.
(2) An indication (denoted as indication #8 for simplicity) for indicating whether a DL synchronization operation is performed by the UE before the cell switching procedure for the at least one candidate cell or not, e.g., an indication for early DL synchronization.
(3) The RACH configuration information for the TA acquisition procedure performed by the UE. In some embodiments, the RACH configuration information includes at least one of: an RA preamble index; an SS/PBCH index; or an RO. A specific example is described in the embodiments of FIG. 7 as follows.

In some embodiments, information #1 may be included in or outside of the RRC configuration information, which is associated with the at least one candidate cell, in message #1.

In some embodiments, the RACH configuration information is included in a dedicated IE in message #1. In an embodiment, the RACH configuration information is included in “CU to DU RRC information IE” (as specified in 3GPP standard document TS38.473) included in message #1, e.g., as a sub-IE of “CU to DU RRC information IE”. In another embodiment, the RACH configuration information is included in the response message as an IE outside of “CU to DU RRC information IE”, e.g., in parallel with “CU to DU RRC information IE”.

In some other embodiments, message #1 includes one or more IEs including the lower layer RRC configuration information, and the RACH configuration information is merged to the one or more IEs within message #1.

In some embodiments, message #1 further includes at least one of the following:
(1) An indication (denoted as indication #9 for simplicity) for indicating whether a TA value related to the at least one candidate cell is the same as a TA value related to another candidate cell (e.g., candidate cell #1 as described in the embodiments of FIG. 3) within the one or more candidate cells.
(2) ID information of the another candidate cell, if the TA value related to the at least one candidate cell is the same as the TA value related to the another candidate cell. A specific example is described in the embodiments of FIG. 8 as follows.

FIG. 5 illustrates another exemplary flowchart associated with a cell switching procedure in accordance with some embodiments of the present application. The exemplary flowchart 500 in the embodiments of FIG. 5 may be performed by a source DU (e.g., DU2 or DU1 as shown and illustrated in FIG. 2). Although described with respect to a source DU, it should be understood that other devices may be configured to perform a flowchart similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-10.

In the exemplary flowchart 500 as shown in FIG. 5, in operation 501, a source DU (e.g., DU2 as shown and illustrated in FIG. 2) may receive a message (e.g., message #1 as described in the embodiments of FIG. 4) from a CU of the BS (e.g., CU as shown and illustrated in FIG. 2). The received message may include RRC configuration information associated with at least one candidate cell related to a cell switching procedure.

In some embodiments, the message received in operation 501 further includes at least one of following information (e.g., information #1 as described in the embodiments of FIG. 4), and such information may be included in or outside of the RRC configuration information in the received message:
(1) An indication for indicating whether a TA acquisition is performed by the UE before the cell switching procedure for the at least one candidate cell or not, e.g., an indication for early TA acquisition (e.g., indication #7 as described in the embodiments of FIG. 4).
(2) An indication for indicating whether a DL synchronization operation is performed by the UE before the cell switching procedure for the at least one candidate cell or not, e.g., an indication for early DL synchronization (e.g., indication #8 as described in the embodiments of FIG. 4).
(3) RACH configuration information for the TA acquisition procedure performed by the UE. In some embodiments, the RACH configuration information includes at least one of: an RA preamble index; an SS/PBCH index; or an RO.

In some embodiments, the RACH configuration information is included in a dedicated IE in the message received in operation 501. In an embodiment, the RACH configuration information is included in a sub-IE of “CU to DU RRC information IE”. In another embodiment, the RACH configuration information is included in an IE outside of “CU to DU RRC information IE”, e.g., in parallel with “CU to DU RRC information IE”. In some other embodiments, the lower layer RRC configuration information is included in one or more IEs in the message received in operation 501, and the RACH configuration information is merged to the one or more IEs.

In some embodiments, the message received in operation 501 further includes at least one of the following:
(1) an indication for indicating whether a TA value related to the at least one candidate cell is the same as a TA value related to another candidate cell (e.g., candidate cell #1 as described in the embodiments of FIG. 4) associated with the LTM, e.g., indication #9 as described in the embodiments of FIG. 4. (
2) ID information of the another candidate cell, if the TA value related to the at least one candidate cell is the same as the TA value related to the another candidate cell

In some embodiments, before receiving message in operation 501, the source DU may transmit “a request for requesting a RACH resource for a TA acquisition procedure performed by the UE”to the CU.

In operation 502 as shown in FIG. 5, the source DU may transmit another message (denoted as message #2 for simplicity) including the RRC configuration information to the UE (e.g., UE 102 as shown and illustrated in FIG. 1). In some embodiments, message #2 is an RRC reconfiguration message.

In some embodiments, message #2 further includes at least one of the following:
(1) An indication (denoted as indication #10 for simplicity) for indicating whether a TA acquisition procedure is performed by the UE before the cell switching procedure for the at least one candidate cell or not, e.g., an indication for early TA acquisition.
(2) An indication (denoted as indication #11 for simplicity) for indicating whether a DL synchronization operation is performed by the UE before the cell switching procedure for the at least one candidate cell or not, e.g., an indication for early DL synchronization.
(3) RACH configuration information for the TA acquisition procedure performed by the UE. In some embodiments, the RACH configuration information includes at least one of: an RA preamble index; an SS/PBCH index; or an RO. A specific example is described in the embodiments of FIG. 7 as follows.

In some embodiments, message #2 may include at least one of the following:
(1) An indication (denoted as indication #12 for simplicity) for indicating whether a TA value related to the at least one candidate cell is the same as a TA value related to another candidate cell (e.g., candidate cell #1 as described in the embodiments of FIG. 4) associated with the LTM.
(2) ID information of the another candidate cell, if the TA value related to the at least one candidate cell is the same as the TA value related to the another candidate cell. A specific example is described in the embodiments of FIG. 8 as follows.

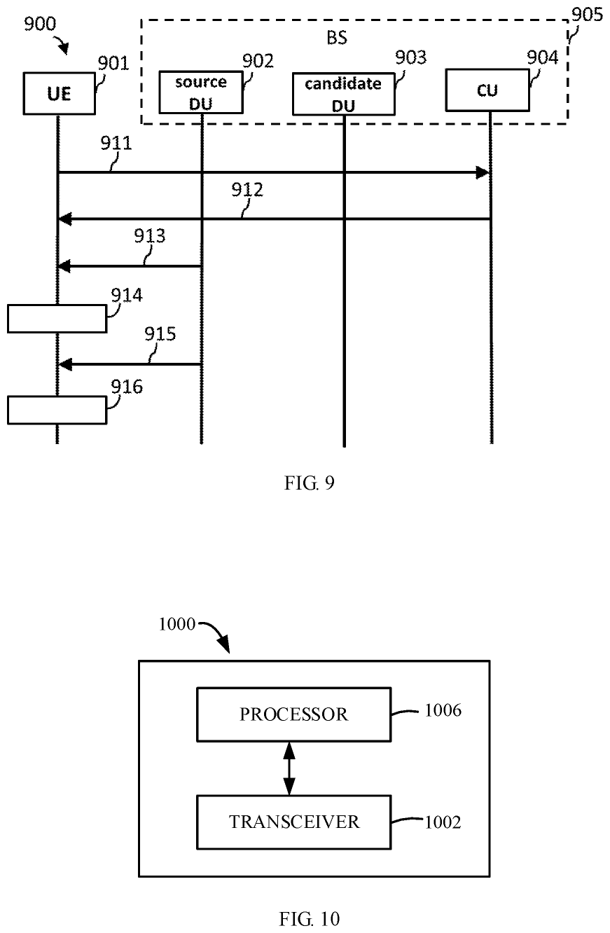

In some embodiments, after transmitting message #2, the source DU may transmit an indication (denoted as indication #13 for simplicity), which may be included in a PDCCH order, DCI, or a MAC CE, to the UE. Indication #13 may indicate at least one of the following:
(1) to perform a ta acquisition procedure;
(2) whether to create a dedicated MAC entity associated with the at least one candidate cell for the TA acquisition procedure performed by the UE; or
(3) to perform a DL synchronization operation to the at least one candidate cell. A specific example is described in the embodiments of FIGS. 8 and 9 as follows.

FIG. 6 illustrates yet another exemplary flowchart associated with a cell switching procedure in accordance with some embodiments of the present application. The exemplary flowchart 600 in the embodiments of FIG. 6 may be performed by a UE (e.g., UE 102 as shown and illustrated in FIG. 1). Although described with respect to a UE, it should be understood that other devices may be configured to perform a flowchart similar to that of FIG. 6. Details described in all other embodiments of the present application are applicable for the embodiments of FIG. 6. Moreover, details described in the embodiments of FIG. 6 are applicable for all the embodiments of FIGS. 1-5 and 7-10.

In the exemplary flowchart 600 as shown in FIG. 6, in operation 601, a UE may receive a message from a source DU of a BS (e.g., DU2 as shown and illustrated in FIG. 2). The message may include RRC configuration information associated with at least one candidate cell related to a cell switching procedure. In some embodiments, the message is an RRC reconfiguration message.

In some embodiments, the message received by the UE in operation 601 further includes at least one of the following:
(1) An indication for indicating whether the TA acquisition procedure is performed by the UE before the cell switching procedure for the at least one candidate cell or not, e.g., an indication for early TA acquisition (e.g., indication #10 as described in the embodiments of FIG. 5).
(2) An indication for indicating whether a DL synchronization operation is performed by the UE before the cell switching procedure for the at least one candidate cell or not, e.g., an indication for early DL synchronization (e.g., indication #11 as described in the embodiments of FIG. 5).
(3) RACH configuration information for the TA acquisition procedure. In some embodiments, the RACH configuration information includes at least one of: a RA preamble index; a SS/PBCH index; or an RO.

In some embodiments, the message received by the UE in operation 601 further includes at least one of the following:
(1) An indication for indicating whether a TA value related to the at least one candidate cell is the same as a TA value related to another candidate cell (e.g., candidate cell #1 as described in the embodiments of FIG. 4) associated with the LTM, e.g., indication #12 as described in the embodiments of FIG. 5.
(2) ID information of the another candidate cell, if the TA value related to the at least one candidate cell is the same as the TA value related to the another candidate cell.

In operation 602 as shown in FIG. 6, the UE may receive an indication (e.g., indication #13 as described in the embodiments of FIG. 5) to trigger a TA acquisition procedure or a DL synchronization operation from the source DU. The indication may be included in a PDCCH order, DCI, or a MAC CE.

In some embodiments, the UE may start to perform the DL synchronization operation to the at least one candidate cell after receiving the message in operation 601.

In some embodiments, the UE may perform the TA acquisition procedure before the cell switching procedure after receiving the RRC configuration information associated with the at least one candidate cell in the message in operation 601.

In some embodiments, the UE may perform the TA acquisition procedure based on a MAC entity of the UE or an RLC entity of the UE.

In some embodiments, the UE may determine to create a dedicated MAC entity for the TA acquisition procedure based on one of the following:
(1) Receiving an indication from the source DU (e.g., indication #13 as described in the embodiments of FIG. 5). The indication may indicate the UE to create a MAC entity associated with the at least one candidate cell for the TA acquisition procedure. In some embodiments, the indication is included in: the message received by the UE in operation 601; a PDCCH order; DCI; or a MAC CE.
(2) An index of a candidate DU of the BS is different from an index of the source DU.
(3) An index of a candidate cell group of the BS is different from an index of a source cell group of the BS.

In some embodiments, in response to determining to create the dedicated MAC entity for the TA acquisition procedure, the UE may perform at least one of:
(1) creating the MAC entity for the TA acquisition procedure; or
(2) creating an RLC entity associated with the at least one candidate cell for the TA acquisition procedure.

In some embodiments, the MAC entity and/or the RLC entity is created by the UE based on default configuration information configured to the UE. In an embodiment, the UE may release both the MAC entity and the RLC entity after acquiring a TA value related to the at least one candidate cell by the TA acquisition procedure.

In some other embodiments, the MAC entity and/or the RLC entity is created by the UE based on the RRC configuration information associated with the at least one candidate cell. In an embodiment, the UE may keep the MAC entity and/or the RLC entity after acquiring a TA value related to the at least one candidate cell by the TA acquisition procedure.

In some embodiments, if the at least one candidate cell includes two candidate cells, e.g., candidate cell #2 and candidate cell #3, the UE may create a MAC entity and/or an RLC entity for candidate cell #2, and keep the MAC entity and/or the RLC entity for candidate cell #2 after acquiring a TA value related to candidate cell #2; and the UE may create a MAC entity and/or an RLC entity for candidate cell #3, and keep the MAC entity and/or the RLC entity for candidate cell #3 after acquiring a TA value related to candidate cell #3.

In an embodiment, the UE may receive a cell switch command associated with candidate cell #3 from the source DU. After switching from the source cell of the UE to candidate cell #3, the UE may keep or release the MAC entity and/or the RLC entity for candidate cell #2. A specific example is described in the embodiments of FIG. 9 as follows.

The following text describes specific embodiments of the flowchart as shown and illustrated in any of FIGS. 3-6. It should be appreciated by persons skilled in the art that the sequence of the operations in any of exemplary flowcharts 700, 800, and 900 in FIGS. 7-9 may be changed and some of the operations in any of exemplary flowcharts 700, 800, and 900 in FIGS. 7-9 may be eliminated or modified, without departing from the spirit and scope of the disclosure.

FIG. 7 illustrates an exemplary flowchart of performing a cell change procedure in accordance with some embodiments of the present application. Details described in all other embodiments of the present application are applicable for the embodiments shown in FIG. 7.

As shown in FIG. 7, BS 705 is in CU-DU architecture, and includes CU 704, source DU 702, and candidate DU 703. In the embodiments of FIG. 7, a cell switching operation performed by UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell switching operation in an Inter-DU case for the exemplary purpose. The flowchart 700 also can be applied to an intra-DU case if source DU 702 and candidate DU 703 are the same DU.

In the exemplary flowchart 700 as shown in FIG. 7, in operation 711, UE 701 may access the serving BS (e.g., gNB) and send a measurement report to the serving BS, for example, BS 705. The serving BS may include a CU (e.g., gNB-CU) and one or more DUs (e.g., gNB-DUs). A serving cell is associated with a CU and a DU. There is an F1 interface between the DU and the CU. For example, as shown in FIG. 7, BS 705 includes CU 704, source DU 702, and candidate DU 703. BS 705 may include one or more other candidate DUs (not shown in FIG. 7).

In some embodiments, UE 701 may send the measurement report to CU 704 via source DU 702. For instance, UE 701 may send the measurement report, which contains measurement result(s) of neighboring cell(s), to source DU 702. Source DU 702 may send an UL RRC MESSAGE TRANSFER message including the measurement report to CU 704.

In operation 712, CU 704 may determine to initiate a L1/L2 based inter-cell mobility configuration procedure, i.e., making a L1/L2 based inter-cell mobility configuration decision.

In operation 713, CU 704 may send a request of RACH resource for TA acquisition to candidate DU 703 via an F1 interface. The request may contain ID information of candidate cell(s). In some embodiments, a candidate cell may also be named as “a target candidate cell” or the like. In Inter-DU case, the request may be a UE CONTEXT SETUP REQUEST message. In Intra-DU case, the request may be a UE CONTEXT MODIFICATION REQUEST message.

In some embodiments, the request in operation 713 may include at least one of the following:
(1) An indication for indicating whether a TA acquisition procedure is performed by the UE before the cell switching procedure for at least one candidate cell or not, e.g., an indication for early TA acquisition (e.g., indication #3 as described in the embodiments of FIG. 3). This indication is used to indicate whether early TA acquisition is needed for at least one candidate cell or not. Early TA acquisition means that UE 701 is expected to perform the TA acquisition before a cell switching procedure.
(2) An indication for indicating whether a DL synchronization operation is performed by the UE before the cell switching procedure for the at least one candidate cell or not, e.g., an indication for early DL synchronization (e.g., indication #4 as described in the embodiments of FIG. 3). This indication is used to indicate whether early DL synchronization is needed for at least one candidate cell or not. Early DL synchronization means UE 701 is expected to perform the DL synchronization operation before the cell switching procedure.

Before operation 713, source DU 702 may transmit a request of RACH resource for TA acquisition to CU 704 via an F1 interface. The request is for requesting CU 704 to provide the configuration for TA acquisition of UE 701, for example, RACH configuration information which indicates a RACH resource for early TA acquisition. The request may contain ID information of the candidate cell(s). Then, CU 704 may transmit the F1 request message to candidate DU 703 in operation 713.

In operation 714, candidate DU 703 may transmit a response message to CU 704 via an F1 interface, i.e., the F1 response message. In Inter-DU case, the F1 response message may be a UE CONTEXT SETUP RESPONSE message. In Intra-DU case, the F1 response message may be a UE CONTEXT MODIFICATION RESPONSE message. In some embodiments, the F1 response message is transmitted in operation 714 after candidate DU 703 decides to accept the request of LTM configuration in operation 713.

In some embodiments, the F1 response message in operation 714 may include the lower layer RRC configuration for the target cell(s), which may be named as “lower layer RRC configuration for LTM”as described in FIGS. 3 and 4.

In some embodiments, the F1 response message in operation 714 may include at least one of the following information, and, for example, such information can be included in an RRCReconfiguration message:
(1) An indication for early TA acquisition (e.g., indication #1 as described in the embodiments of FIG. 3), which is used to indicate whether early TA acquisition is needed for a candidate cell or not. Early TA acquisition means that UE 701 is expected to perform the TA acquisition before a cell switching procedure.
(2) RACH configuration for TA acquisition, which may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #2 as described in the embodiments of FIG. 3), which is used to indicate whether an early DL synchronization is needed for a candidate cell or not. Early DL synchronization means UE 701 is expected to perform the DL synchronization operation before the cell switching procedure.

Regarding how to carry the above information for TA acquisition in the F1 response message from candidate DU 703 to CU 704 in operation 714, there may be following three options in different embodiments as below, i.e., Option A, Option B, and Option C.
(1) Option A: RACH configuration for TA acquisition is a separate IE included in the F1 response message in operation 714. Namely, RACH configuration for TA acquisition is not merged to lower layer RRC configuration for LTM in the F1 response message. For example, RACH configuration for TA acquisition as a separate IE may be included in “DU to CU RRC information IE” (as specified in 3GPP standard document TS38.473) of the F1 response message in operation 714. In this option, if the indication for early TA acquisition is not included, RACH configuration for TA acquisition as a separate IE can be used to implicitly indicate early TA acquisition.
(2) Option B: RACH configuration for TA acquisition can be merged to lower layer RRC configuration for LTM included in the F1 response message in operation 714. In this way, the indication for early TA acquisition is needed. If the indication for early TA acquisition is not included in the F1 response message, CU 704 needs to read the container. If the RACH configuration for TA acquisition is included, CU 704 needs to indicate the early TA acquisition and the corresponding RACH resource to source DU 702.
(3) Option C: RACH configuration for TA acquisition is outside of “DU to CU RRC information IE” included in the F1 response message in operation 714. In this option, if the indication for early TA acquisition is not included, the RACH configuration for TA acquisition as a separate IE can be used to implicitly indicate early TA acquisition.

In operation 715, CU 704 may send an F1 message (e.g., message #1 as described in the embodiments of FIG. 4), which includes the RRCReconfiguration message which includes lower layer RRC configuration for LTM, to source DU 702. Some configuration in RRCReconfiguration message may be generated by a target DU, e.g., candidate DU 703. In some embodiments, the F1 message in operation 715 can be a DL RRC MESSAGE TRANSFER message or a UE CONTEXT MODIFICATION REQUEST message.

In some embodiments, the F1 message in operation 715 includes at least one of the following information (e.g., information #1 as described in the embodiments of FIG. 4), and for example, such information can be included in an RRCReconfiguration message in the F1 message:
(1) An indication for early TA acquisition (e.g., indication #7 as described in the embodiments of FIG. 4), to indicate whether early TA acquisition is needed for a candidate cell or not. Early TA acquisition means that UE 701 is expected to perform the TA acquisition before a cell switching procedure.
(2) RACH configuration for TA acquisition, which may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #8 as described in the embodiments of FIG. 4), to indicate whether early DL synchronization is needed for one candidate cell or not. Early DL synchronization means UE 701 is expected to perform the DL synchronization operation before the cell switching procedure.

Regarding how to carry the above information for TA acquisition (e.g., information #1 as described in the embodiments of FIG. 4) in the F1 message from CU to source DU 702 in operation 715, there may be following three options in different embodiments as below, i.e., Option X, Option Y, and Option Z.
(1) Option X: RACH configuration for TA acquisition is a separate IE included in the F1 message in operation 715. Namely, RACH configuration for TA acquisition is not merged to lower layer RRC configuration for LTM in the F1 message. For example, RACH configuration for TA acquisition as a separate IE may be included in “CU to DU RRC information IE” (as specified in 3GPP standard document TS38.473) of the F1 message in operation 715. In this option, if the indication for early TA acquisition is not included, the RACH configuration for TA acquisition as a separate IE can be used to implicitly indicate early TA acquisition.
(2) Option Y: RACH configuration for TA acquisition can be merged to lower layer RRC configuration for LTM included in the F1 message in operation 715. In this way, the indication for early TA acquisition, a preamble index and/or a time-frequency resource index may be listed in the F1 message.
(3) Option Z: RACH configuration for TA acquisition is outside of “CU to DU RRC information IE” included in F1 message in operation 715. In this option, if the indication for early TA acquisition is not included, the RACH configuration for TA acquisition as a separate IE can be used to implicitly indicate early TA acquisition.

In operation 716, source DU 702 may forward a message (e.g., message #2 as described in the embodiments of FIG. 5) including the received RRCReconfiguration message to UE 701. In some embodiments, the message in operation 716 may include the following information:
(1) An indication for early TA acquisition (e.g., indication #10 as described in the embodiments of FIG. 5), to indicate to UE 701 whether early TA acquisition is needed for a candidate cell or not.
(2) RACH configuration for TA acquisition, which may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #11 as described in the embodiments of FIG. 5), to indicate to UE 701 whether early DL synchronization is needed for one candidate cell or not.

In some embodiments, once UE 701 receives the configuration of a target cell (e.g., the RRCReconfiguration message) in operation 716, UE 701 may start to perform a DL synchronization operation to the target cell.

In operation 717, UE 701 may transmit an RRC response message to source DU 702. For instance, the RRC response message may be an RRC Reconfiguration Complete message. In some embodiments, source DU 702 may forward the RRC Reconfiguration Complete message to CU 704 via an F1 message, e.g., an UL RRC MESSAGE TRANSFER message or a UE Context Modification Response message.

In operation 718, source DU 702 may transmit an indication (e.g., indication #13 as described in the embodiments of FIG. 5) to UE 701, to trigger UE 701 to perform a TA acquisition procedure. For instance, the indication is included in an RRC message, a PDCCH order, DCI, or a MAC CE. In some embodiments, the indication may include a dedicated preamble and/or a dedicated time-frequency domain resource, which is configured by candidate DU 703.

In some embodiments, source DU 702 may transmit an indication (e.g., indication #13 as described in the embodiments of FIG. 5) to UE 701 in operation 718, to indicate to UE 701 whether to perform a DL synchronization operation to the configured candidate cell. This indication may be included in an RRC message, a PDCCH order, DCI, or a MAC CE.

In operation 719A, UE 701 may perform the TA acquisition procedure. In addition, in operation 719B, UE 701 may send L1 measurement result(s) to source DU 702.

In some embodiments, the TA acquisition procedure includes a preamble transmission. In an embodiment, if a random access response (RAR) is included in the TA acquisition procedure, UE 701 may get or acquire the TA value from the candidate cell. In another embodiment, if a RAR is not included in the TA acquisition procedure, UE 701 may get or acquire the TA value from the source cell; the candidate cell receives the dedicated preamble and calculates the TA value; and then, the candidate cell may transmit the TA value and ID information of the corresponding candidate cell and ID information of UE 701 to source DU 702 via CU 704.

In operation 720, once source DU 702 decides to execute LTM to a candidate target cell, i.e., to perform a cell switching procedure to the candidate target cell, source DU 702 may transmit a cell switch command, e.g., a MAC CE including a candidate cell configuration index, to UE 701 to trigger the cell switching procedure.

In operation 721, UE 701 may perform the cell switching procedure and synchronize to the candidate target cell, e.g., performing the UL synchronization and/or DL synchronization operations to the candidate target cell.

FIG. 8 illustrates a further exemplary flowchart of performing a cell change procedure in accordance with some embodiments of the present application. Details described in all other embodiments of the present application are applicable for the embodiments shown in FIG. 8.

As shown in FIG. 8, BS 805 is in CU-DU architecture, and includes CU 804, source DU 802, and candidate DU 803. In the embodiments of FIG. 8, a cell switching operation performed by UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell switching operation in an Inter-DU case for the exemplary purpose. The flowchart 800 also can be applied to an intra-DU case if source DU 802 and candidate DU 803 are the same DU.

In the exemplary flowchart 800 as shown in FIG. 8, in operation 811, UE 801 may access the serving BS (e.g., gNB) and send a measurement report to the serving BS, for example, BS 805. The serving BS may include a CU (e.g., gNB-CU) and one or more DUs (e.g., gNB-DUs). A serving cell is associated with a CU and a DU. There is F1 interface between the DU and CU. For example, as shown in FIG. 8, BS 805 includes CU 804, source DU 802, and candidate DU 803. BS 805 may include one or more other candidate DUs (not shown in FIG. 8).

In some embodiments, UE 801 may send the measurement report, which contains measurement result(s) of neighboring cell(s), to source DU 802. Source DU 802 may send an UL RRC MESSAGE TRANSFER message including the measurement report to CU 804.

In operation 812, CU 804 may determine to initiate L1/L2 based inter-cell mobility configuration procedure, i.e., making a L1/L2 based inter-cell mobility configuration decision.

In operation 813, CU 804 may send a request of RACH resource for TA acquisition to candidate DU 803 via an F1 interface, e.g., an F1 request message. The F1 request message may contain ID information of candidate cell(s) and may also be named as “a request of LTM configuration” or the like. In Inter-DU case, the F1 request message may be UE CONTEXT SETUP REQUEST message. In Intra-DU case, the F1 request message may be a UE CONTEXT MODIFICATION REQUEST message.

In some embodiments, the F1 request message in operation 813 may include at least one of the following:
(1) An indication for indicating whether a TA acquisition procedure is performed by the UE before the cell switching procedure for at least one candidate cell or not, e.g., an indication for early TA acquisition (e.g., indication #3 as described in the embodiments of FIG. 3). This indication is used to indicate whether early TA acquisition is needed for a candidate cell or not. Early TA acquisition means that UE 801 is expected to perform a TA acquisition procedure before the cell switching procedure.
(2) RACH configuration for TA acquisition, which may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for indicating whether a DL synchronization operation is performed by the UE before the cell switching procedure for the at least one candidate cell or not, e.g., an indication for early DL synchronization (e.g., indication #4 as described in the embodiments of FIG. 3). This indication is used to indicate whether early DL synchronization is needed for one candidate cell or not. Early DL synchronization means that UE 801 is expected to perform DL synchronization before the cell switching procedure.

Before operation 813, source DU 802 may transmit a request of RACH resource for TA acquisition to CU 804 via an F1 interface. The request is for requesting CU 804 to provide the configuration for TA acquisition procedure of UE 801, for example, RACH configuration information which indicates a RACH resource for early TA acquisition. The request may contain ID information of the candidate cell(s). The request may also be named as “a request of LTM configuration” or the like. Then, CU 804 may transmit the request message to candidate DU 803 in operation 813.

In some embodiments, the request from source DU 802 to CU 804 may include at least one of the following information:
(1) An indication (e.g., indication #5 as described in the embodiments of FIG. 3) to indicate that this F1 request message is for requesting RRC configuration for LTM.
(2) ID information of the candidate cell(s), to indicate candidate cell(s) for LTM configuration.
(3) ID information of source DU 802.
(4) ID information of UE 801 (e.g., source CU/DU UE F1AP ID).
(5) Id Information of a Source Cell of Ue 801.

In some embodiments, source DU 802 may also send assisted information, e.g., including the existing TA value, to the target DU (e.g., candidate DU 803) via CU 804, so that the target DU can decide whether early TA acquisition is needed or whether to reuse the existing TA value.

In operation 814, candidate DU 803 may transmit the response message to CU 804 via an F1 interface. In Inter-DU case, the F1 response message may be a UE CONTEXT SETUP RESPONSE message. In Intra-DU case, the F1 response message may be a UE CONTEXT MODIFICATION RESPONSE message. In some embodiments, the F1 response message is transmitted in operation 814 after candidate DU 803 decides to accept the request in operation 813.

In some embodiments, the F1 response message in operation 814 includes the lower layer RRC configuration for target cell(s), which may be named as “lower layer RRC configuration for LTM”as described in FIGS. 3 and 4.

In some embodiments, the F1 response message in operation 814 includes at least one of the following information, and, for example, such information can be included in an RRCReconfiguration message:
(1) An indication for early TA acquisition (e.g., indication #1 as described in the embodiments of FIG. 3), which is used to indicate whether early TA acquisition is needed for a candidate cell or not. Early TA acquisition means that UE 801 is expected to perform a TA acquisition procedure before the cell switching procedure.
(2) RACH configuration for TA acquisition, which may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #2 as described in the embodiments of FIG. 3), which is used to indicate whether early DL synchronization is needed for one candidate cell or not. Early DL synchronization means that UE 801 is expected to perform DL synchronization before the cell switching procedure.

In some embodiments, before operation 814, candidate DU 803 may identify whether the prepared candidate cell and another candidate cell have a same TA value for the same UE (e.g., UE 801), for example, based on the received ID information of UE 801 (e.g., source CU/DU UE F1AP ID) and ID information of the source cell or based on receiving the same request message. After the identification, the F1 response message in operation 814 may include at least one of the following information:
(1) One indication (e.g., indication #6 as described in the embodiments of FIG. 3) to indicate whether a TA value for the prepared candidate cell is the same as a TA value for another candidate cell (e.g., candidate cell #1 as described in the embodiments of FIG. 3).
(2) ID information of another candidate cell, if the TA value related to this candidate cell is the same as the TA value related to the another candidate cell.

In operation 815, CU 804 may send an F1 message (e.g., message #1 as described in the embodiments of FIG. 4), which includes the generated RRCReconfiguration message with LTM configuration, to source DU 802. This F1 message may be a DL RRC MESSAGE TRANSFER message or a UE CONTEXT MODIFICATION REQUES message.

In some embodiments, the F1 message in operation 815 may include at least one of the following information (e.g., information #1 as described in the embodiments of FIG. 4), and for example, such information can be included in an RRCReconfiguration message in the F1 message:
(1) An indication for early TA acquisition (e.g., indication #7 as described in the embodiments of FIG. 4), to indicate whether early TA acquisition is needed for a candidate cell or not. Early TA acquisition means that UE 801 is expected to perform a TA acquisition procedure before a cell switching procedure.
(2) RACH configuration for TA acquisition may include at least one of the following:
   a) An RA Preamble index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #8 as described in the embodiments of FIG. 4), to indicate whether early DL synchronization is needed for one candidate cell or not. Early DL synchronization means that UE 801 is expected to perform DL synchronization before a cell switching procedure.

In some embodiments, the F1 message in operation 815 includes at least one of the following information:
(1) An indication (e.g., indication #9 as described in the embodiments of FIG. 4) to indicate whether TA for this candidate cell is same as another candidate cell.
(2) ID information of the another candidate cell, if the TA value related to the at least one candidate cell is the same as the TA value related to the another candidate cell.

In operation 816, source DU 802 forwards a message (e.g., message #2 as described in the embodiments of FIG. 5) including the received RRCReconfiguration message to UE 801. In some embodiments, the message in operation 816 may include at least one of the following information:
(1) An indication for early TA acquisition (e.g., indication #10 as described in the embodiments of FIG. 5), to indicate to UE 801 whether early TA acquisition is needed for a candidate cell or not.
(2) RACH configuration for TA acquisition, which may include at least one of the following:
   a) an Ra Preamble Index.
   b) An SS/PBCH index. This field may indicate the SS/PBCH that shall be used to determine the RACH occasion for the PRACH transmission.
   c) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.
(3) An indication for early DL synchronization (e.g., indication #11 as described in the embodiments of FIG. 5), to indicate to UE 801 whether early DL synchronization is needed for one candidate cell or not.

In some embodiments, the message in operation 816 may include at least one of the following information.
(1) One indication (e.g., indication #12 as described in the embodiments of FIG. 5) to indicate whether a TA value for the candidate cell is the same as a TA value for another candidate cell.
(2) ID of another candidate cell, if the TA value for the candidate cell is the same as the TA value for the another candidate cell.

In operation 817, UE 801 may transmit an RRC response message to source DU 802. The RRC response message can be an RRC Reconfiguration Complete message. In some embodiments, source DU 802 may forward the RRC Reconfiguration Complete message to CU 804 via an F1 message, e.g., an UL RRC MESSAGE TRANSFER message or a UE Context Modification Response message.

In operation 818, once source DU 802 decides to execute LTM to a candidate target cell, i.e., to perform a cell switching procedure to the candidate target cell, source DU 802 may transmit a cell switch command, e.g., a MAC CE including candidate cell configuration index, to UE 801 to trigger the cell switching procedure.

In operation 819, UE 801 may perform the cell switching procedure and synchronize to the candidate target cell, e.g., performing the UL synchronization and/or DL synchronization operations to the candidate target cell. In some embodiments, if UE 801 receives an indication for early TA acquisition (e.g., indication #10 as described in the embodiments of FIG. 5) in operation 816, UE 801 may perform a TA acquisition procedure before the cell switching procedure, to acquire the TA value of the candidate target cell. In some embodiments, if UE 801 receives an indication (e.g., indication #12 as described in the embodiments of FIG. 5), which indicates whether a TA value for the candidate target cell is the same as a TA value for another candidate cell, in operation 816, UE 801 may use the TA value of the another candidate cell in operation 819.

FIG. 9 illustrates another exemplary flowchart of performing a cell change procedure in accordance with some embodiments of the present application. Details described in all other embodiments of the present application are applicable for the embodiments shown in FIG. 9.

As shown in FIG. 9, BS 905 is in CU-DU architecture, and includes CU 904, source DU 902, and candidate DU 903. In the embodiments of FIG. 9, a cell change of UE 901 may refer to an Intra-DU case in which a source cell and a target cell in the same DU or refer to an Inter-DU case in which a source cell and a target cell are located at different DUs. For instance, the flowchart 900 as shown in FIG. 9 only shows a cell change in an Inter-DU case for the exemplary purpose. The flowchart 900 can be applied to an intra-DU case if source DU 902 and candidate DU 903 are the same DU.

In the exemplary flowchart 900 as shown in FIG. 9, in operation 911, UE 901 may access the serving BS (e.g., gNB) and send a measurement report to the serving BS, for example, BS 905. The serving BS may include a CU (e.g., gNB-CU) and one or more DUs (e.g., gNB-DUs). A serving cell is associated with a CU and a DU. There is F1 interface between the DU and the CU. For example, as shown in FIG. 9, BS 905 includes CU 904, source DU 902, and candidate DU 903. BS 905 may include one or more other candidate DUs (not shown in FIG. 9).

In some embodiments, UE 901 may send the measurement report to CU 904 via source DU 902. For instance, UE 901 may send the measurement report, which contains measurements result(s) of neighboring cell(s), to source DU 902. Source DU 902 may send an UL RRC MESSAGE TRANSFER message including the measurement report to CU 904.

In operation 912, CU 904 may transmit an RRCReconfiguration message associated with one or more than one candidate cell(s) for LTM purpose to UE 901 via source DU 902.

In some embodiments, CU 904 may determine to initiate L1/L2 based inter-cell mobility configuration procedure, i.e., making a L1/L2 based inter-cell mobility configuration decision. CU 904 may receive the RRCReconfiguration message from a candidate cell via an F1 interface, e.g., from candidate DU 903. Then, CU 904 may forward the RRCReconfiguration message to UE 901 via source DU 902 in operation 912.

In operation 913, UE 901 may receive an indication to trigger a TA acquisition procedure to candidate cell(s) (e.g., indication #13 as described in the embodiments of FIG. 5), e.g., from source DU 902. In some embodiments, the indication is included in a PDCCH order, DCI, or a MAC CE. The indication may indicate UE 901 at least one of the following:
(1) to perform a ta acquisition procedure;
(2) whether to create a dedicated MAC entity associated with at least one candidate cell for the TA acquisition procedure; or
(3) to perform a DL synchronization operation to at least one candidate cell.

In operation 914, UE 901 may determine whether to create a dedicated MAC entity or a separate MAC entity for a TA acquisition procedure. There may be following two options in different embodiments as below, i.e., Option M and Option N.
(1) Option M: UE 901 determines to create or establish a dedicated or separate MAC entity for candidate cell for the TA acquisition procedure. Furthermore, UE 901 may create or establish an RLC entity for candidate cell.
   a) UE 901 may create or establish a dedicated MAC entity and/or a dedicated RLC entity based on the RRC configuration information associated with candidate cell(s), e.g., based on the configuration for candidate cell(s) which includes DU ID, DU index, and/or cell group ID for the candidate cell(s).
   b) In some embodiments, after acquiring a TA value related to the candidate cell(s) by the TA acquisition procedure, UE 901 may keep or release the dedicated MAC entity and/or the dedicated RLC entity.
   c) In an embodiment, if there are two candidate cells, e.g., candidate cell #2 and candidate cell #3, UE 901 may create a dedicated MAC entity and/or a dedicated RLC entity for candidate cell #2, and keep the dedicated MAC entity and/or the dedicated RLC entity for candidate cell #2 after acquiring a TA value related to candidate cell #2. UE 901 may create a dedicated MAC entity and/or a dedicated RLC entity for candidate cell #3, and keep the dedicated MAC entity and/or the dedicated RLC entity for candidate cell #3 after acquiring a TA value related to candidate cell #3. If UE 901 receives a cell switch command associated with candidate cell #3 from source DU 902 (e.g., in operation 915 as below), after switching from the source cell of UE 901 to candidate cell #3, UE 901 may keep or release the MAC entity and/or the RLC entity for candidate cell #2.
   d) The configuration of a MAC entity (or an RLC entity) for the TA acquisition procedure is not the same configuration as for candidate cell(s). For instance, UE 901 may create or establish the dedicated MAC entity and/or the dedicated RLC entity based on default configuration configured to the UE. In an embodiment, after acquiring a TA value related to the candidate cell by the TA acquisition procedure, UE 901 may release both the dedicated MAC entity and the dedicated RLC entity.
(2) Option N: No dedicated or separate MAC entity for the TA acquisition procedure is needed. UE 901 may perform the TA acquisition procedure based on a MAC entity of the UE (i.e., a source MAC entity) or an RLC entity of the UE (i.e., a source RLC entity).

In operation 915, once source DU 902 decides to perform a cell switching procedure to a candidate target cell, source DU 902 may transmit a cell switch command to UE 901 to trigger the cell switching procedure. The cell switch command may be used to trigger UE 901 to perform the TA acquisition procedure. In some embodiments, the cell switch command is included in a MAC CE including candidate cell configuration index. In some other embodiments, the cell switch command is included in DCI or an RRC message.

In operation 916, UE 901 may perform the cell switching procedure and synchronize to the candidate target cell, e.g., performing the UL synchronization and/or DL synchronization operations to the candidate target cell.

FIG. 10 illustrates a block diagram of an exemplary apparatus 1000 in accordance with some embodiments of the present application. As shown in FIG. 10, the apparatus 1000 may include at least one processor 1006 and at least one transceiver 1002 coupled to the processor 1006. Although in this figure, elements such as the at least one transceiver 1002 and processor 1006 are described in the singular, the plural is contemplated unless a limitation to the singular is explicitly stated. In some embodiments of the subject application, the transceiver 1002 may be divided into two devices, such as a receiving circuitry and a transmitting circuitry. In some embodiments of the subject application, the apparatus 1000 may further include an input device, a memory, and/or other components.

In some embodiments of the subject application, the apparatus 1000 may be a UE or a network node (e.g., a BS, a CU, or a DU). The transceiver 1002 and the processor 1006 may interact with each other so as to perform the operations with respect to the UE or the network node described above, for example, in any of FIGS. 1-9.

In some embodiments of the subject application, the apparatus 1000 may further include at least one non-transitory computer-readable medium. For example, in some embodiments of the present disclosure, the non-transitory computer-readable medium may have stored thereon computer-executable instructions to cause the processor 1006 to implement the method with respect to a UE or a network node (e.g., a BS, a CU, or a DU) as described above. For example, the computer-executable instructions, when executed, cause the processor 1006 interacting with transceiver 1002 to perform the operations with respect to the UE or the network node described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A candidate distributed unit (DU) of a base station (BS), comprising:
at least one memory; and
at least one processor coupled with the at least one memory and configured to cause the candidate DU to:
receive a first request from a centralized unit (CU) of the BS, wherein the first request includes identifier (ID) information of one or more candidate cells; and
transmit, based on the first request, a response message to the CU, wherein the response message is associated with a cell switching procedure.

2. The candidate DU of claim 1, wherein the response message includes at least one of:
lower layer radio resource control (RRC) configuration information associated with at least one candidate cell within the one or more candidate cells; or
random access channel (RACH) configuration information for a timing advance (TA) acquisition procedure performed by a user equipment (UE).

3. The candidate DU of claim 2, wherein the RACH configuration information includes at least one of:
a random access (RA) preamble index;
a synchronization signal/physical broadcast channel (SS/PBCH) index; or
a RACH occasion (RO).

4. The candidate DU of claim 2, wherein the RACH configuration information is included in a dedicated information element (IE) in the response message.

5. The candidate DU of claim 4, wherein the RACH configuration information is included in a DU to CU RRC information IE included in the response message.

6. The candidate DU of claim 2, wherein the first request further includes at least one of:
a third indication for indicating whether the TA acquisition procedure is performed by the UE before the cell switching procedure for a candidate cell within the one or more candidate cells or not; or
a fourth indication for indicating whether a downlink (DL) synchronization operation is performed by the UE before the cell switching procedure for the candidate cell or not.

7. A centralized unit (CU) of a base station (BS), comprising:
at least one memory and at least one processor coupled with the at least one memory and configured to cause the CU to:
transmit a first request to a candidate distributed unit (DU) of the BS, wherein the first request includes identifier (ID) information of one or more candidate cells; and
receive a response message from the candidate DU, wherein the response message is associated with a cell switching procedure.

8. The CU of claim 7, wherein the response message includes at least one of:
lower layer radio resource control (RRC) configuration information associated with at least one candidate cell within the one or more candidate cells; or
random access channel (RACH) configuration information for a timing advance (TA) acquisition procedure performed by a user equipment (UE).

9. The CU of claim 8, wherein the at least one processor is configured to cause the CU to transmit a first message to a source DU of the BS, the first message includes the RRC configuration information associated with the at least one candidate cell, and the RRC configuration information includes the lower layer RRC configuration information.

10. The CU of claim 9, wherein the first message further includes first information, and the first information includes at least one of a third indication for indicating whether the TA acquisition procedure is performed by the UE before the cell switching procedure for the at least one candidate cell or not.

11. A user equipment (UE) for wireless communication, comprising:
at least one memory; and at least one processor coupled with the at least one memory and configured to cause the UE to:
receive a first message from a source distributed unit (DU) of a base station (BS), wherein the first message includes radio resource control (RRC) configuration information associated with at least one candidate cell related to a cell switching procedure; and
receive a first indication to trigger a timing advance (TA) acquisition procedure or a downlink (DL) synchronization operation from the source DU.

12. The UE of claim 11, wherein the first message is an RRC reconfiguration message.

13. The UE of claim 11, wherein the first message further includes at least one of:
a second indication for indicating whether the TA acquisition procedure is performed by the UE before the cell switching procedure for the at least one candidate cell or not;
a third indication for indicating whether a downlink (DL) synchronization operation is performed by the UE before the cell switching procedure for the at least one candidate cell or not; or
random access channel (RACH) configuration information for the TA acquisition procedure.

14. The UE of claim 11, wherein the first message further includes at least one of:
a fourth indication for indicating whether a first TA value related to the at least one candidate cell is a same as a second TA value related to a first candidate cell associated with lower layer triggered mobility (LTM); or
ID information of the first candidate cell.

15. The UE of claim 11, wherein the at least one processor is configured to cause the UE to start to perform the DL synchronization operation to the at least one candidate cell after receiving the first message.

16. A method performed by a user equipment (UE), the method comprising:
receiving a first message from a source distributed unit (DU) of a base station (BS), wherein the first message includes radio resource control (RRC) configuration information associated with at least one candidate cell related to a cell switching procedure; and
receiving a first indication to trigger a timing advance (TA) acquisition procedure or a downlink (DL) synchronization operation from the source DU.

17. The method of claim 16, wherein the first message is an RRC reconfiguration message.

18. The method of claim 16, wherein the first message further includes at least one of:
a second indication for indicating whether the TA acquisition procedure is performed by the UE before the cell switching procedure for the at least one candidate cell or not;
a third indication for indicating whether a downlink (DL) synchronization operation is performed by the UE before the cell switching procedure for the at least one candidate cell or not; or
random access channel (RACH) configuration information for the TA acquisition procedure.

19. The method of claim 16, wherein the first message further includes at least one of:
a fourth indication for indicating whether a first TA value related to the at least one candidate cell is a same as a second TA value related to a first candidate cell associated with lower layer triggered mobility (LTM); or
ID information of the first candidate cell.

20. The method of claim 16, further comprising starting to perform the DL synchronization operation to the at least one candidate cell after receiving the first message.
